(19) United States
(12) Patent Application Publication
(10) Pub. No.: US 2012/0156549 A1
(43) Pub. Date: Jun. 21, 2012

(54) ELECTROCHEMICAL CELL AND CONTACT ELEMENT FOR MAKING CONTACT WITH IT

(75) Inventors: Jens Meintschel, Bernsdorf (DE); Andreas Gutsch, Luedinghausen (DE); Claus-Rupert Hohenthanner, Hanau (DE); Torsten Schmidt, Landsberg (DE)

(73) Assignee: LI-TEC BATTERY GMBH, Kamenz (DE)

(21) Appl. No.: 13/202,845

(22) PCT Filed: Feb. 18, 2011
(86) PCT No.: PCT/EP2010/001029

§ 371 Date: Mar. 7, 2012

(30) Foreign Application Priority Data
Feb. 23, 2009 (DE) 10 2009 010 148.9

(51) Int. Cl. H01M 4/70

(52) U.S. Cl. 429/162

(57) ABSTRACT

An output conductor (102, 103, 202, 203, 303, 402) of an electrochemical cell (101, 201), or a contact element (406, 402) for making contact with it has, at least in places, a surface structure which increases the pressure which the output conductor and contact element exert on one another when the output conductor is connected with a force fit to a contact element.

The present invention concerns a galvanic cell, and a contact element for making contact with the former.

Storage elements for electrical energy, for example, of a flat and rectangular form of construction, are of known art, such as, for example, battery cells or capacitors and similar storage elements; in what follows these are designated as galvanic cells, whose electrochemically active content is often surrounded by packaging in the manner of a film, through which are led electrical connections in sheet form, which are often designated as current collectors. Battery cells constructed in this manner are often also designated as pouch or coffee bag cells. The electrical connections of such cells to other cells, for example, when connected in series or parallel to power sources or loads, are, for example, made by a friction-locked pressing together of the current collectors of these cells with contact elements. In particular uneven and contaminated surfaces of the current collectors and/or the contact elements can result in high electrical interface resistances, which can be associated with losses and corresponding heat generation.

The object of the present invention is to contribute to the improvement of this state of affairs, and to specify an effective solution for making contact with the current collectors of galvanic cells. This object is achieved by means of a galvanic cell, and/or by a contact element for making contact with galvanic cells, with features in accordance with one of the independent claims. Advantageous further developments of the invention form the subject of dependent claims.

An inventive galvanic cell has at least two current collectors for purposes of connecting the cell to an energy source, an energy load, or to other galvanic cells when constructing a block of cells, wherein the connection of this cell is made with the aid of contact elements. In accordance with the invention at least one of the current collectors has a surface structure, at least at some locations, which in a friction-locked connection of the current collector with a contact element increases the pressure that the current collector and contact element exert upon one another.

In what follows terms are defined or elucidated, which are used in the context of the description of the present invention.

In terms of the present invention, a galvanic cell is any type of device for the electrical storage of energy. In particular the term thereby includes electrochemical cells of the primary or secondary type, but also other forms of energy stores, such as, for example, capacitors.

In terms of the present invention a contact element is to be understood as an object, with the aid of which a galvanic cell can be connected to an energy load, to an energy source, or to other galvanic cells for purposes of constructing a block of cells. Contact elements in the narrower sense therefore always have—at least—electrically conducting materials, via which a flow of current can take place between a current collector of a cell and a device connected thereto.

Contact elements in the broader sense are, however, to be understood also to include devices, the material of which can, at least in part, be electrically insulating. With the aid of such contact elements in the broader sense the connection of a cell in accordance with its intended purpose to the devices cited is also supported, because for a connection of a cell in accordance with its intended purpose, alongside the procurement of good electrically conducting connections, in some cases the inhibition of such connections at some locations, that is to say, effective insulation, must also be ensured.

In terms of the present invention a surface structure is to be understood as any surface property that is suitable in a friction-locked connection of an object with a base supporting this surface structure for increasing the pressure that this object and the base supporting the surface structure exert on one another.

In the context of the present invention the pressure is thereby to be understood—as is usual in mechanical engineering—as the force per unit area on the surfaces actively participating in the friction-locked connection.

In what follows the invention is described in terms of preferred examples of embodiment with the aid of the figures.

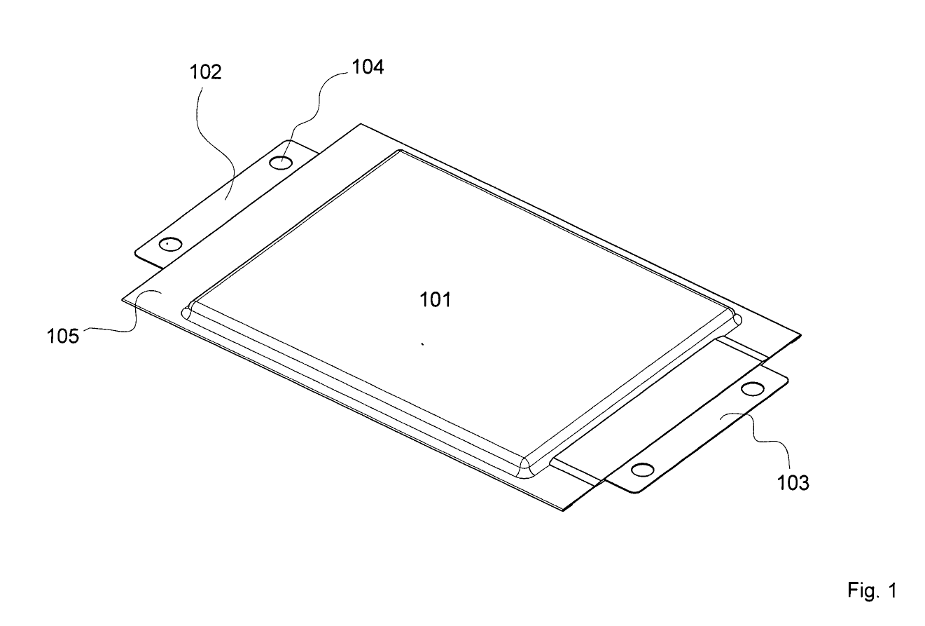

FIG. 1 shows a representation of a typical galvanic cell;

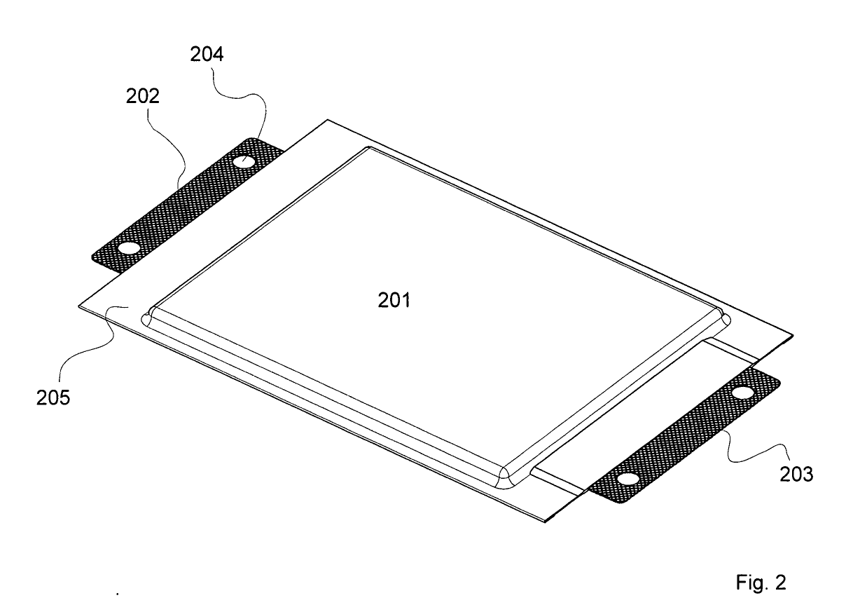

FIG. 2 shows an inventive galvanic cell in accordance with a preferred example of embodiment of the invention;

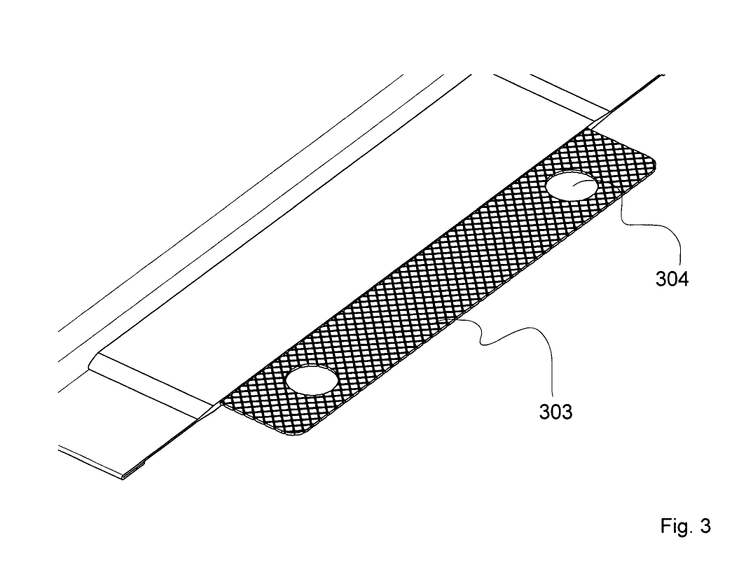

FIG. 3 shows a detailed representation of the cell in accordance with the example of embodiment shown in FIG. 2;

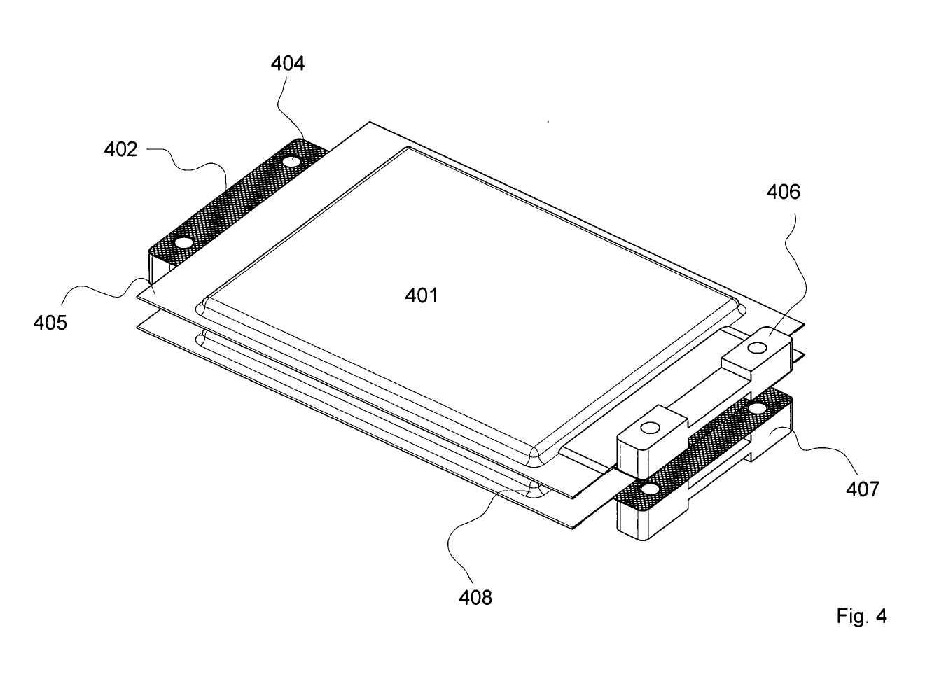

FIG. 4 shows a representation of a block of cells formed from two galvanic cells electrically connected in series via metallic contact elements in accordance with a preferred form of embodiment of the invention;

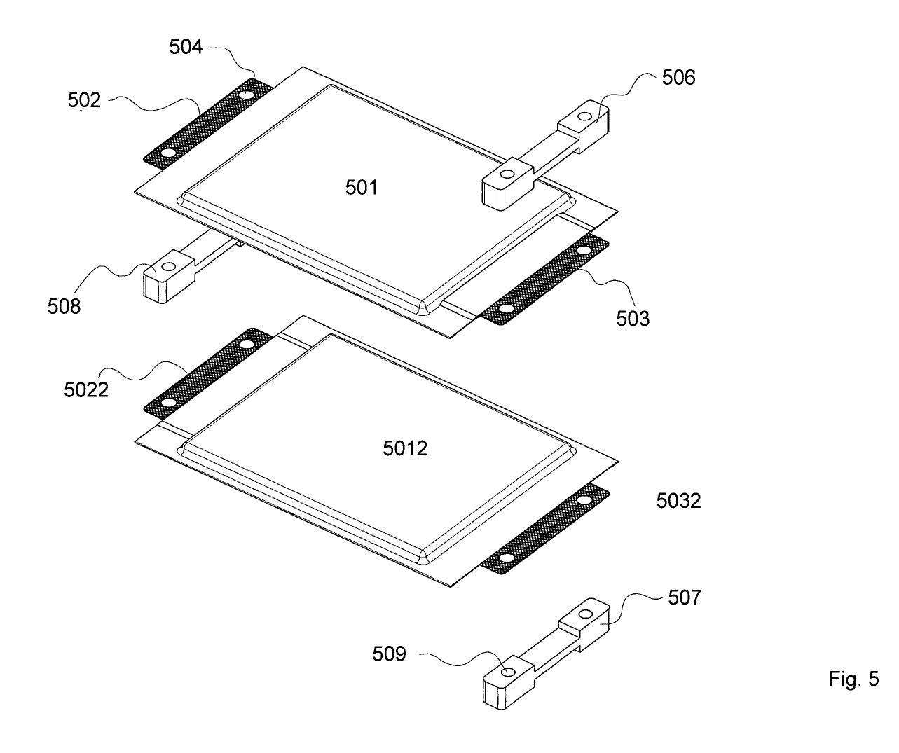

FIG. 5 shows an exploded view of the block of cells shown in FIG. 4;

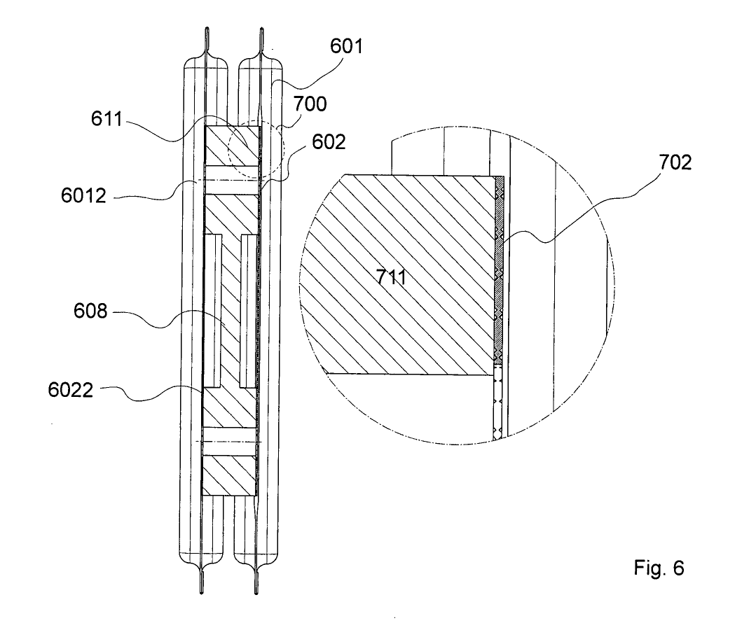

FIG. 6 shows a cross-section and a related magnified detail of the block of cells shown in FIG. 4.

As represented in FIG. 1, a typical galvanic cell 101 has packaging 105 and at least two current collectors 102, 103, wherein openings or cut-outs 104 can be provided in the current collectors, which support the fixing of this cell as it is mounted. Galvanic cells with a flat form of construction are preferred, as shown in FIG. 1, since these cells can be mounted together particularly easily by appropriate stacking to form blocks of cells.

FIG. 2 shows a corresponding galvanic cell 201 with packaging 205 and current collectors 202, 203, wherein the current collectors of the cell in the whole of the region external to the packaging are provided with an appropriate surface structure, preferably by means of knurling, by which, in a friction-locked connection of a current collector with a contact element, the pressure between the current collector and the contact element is increased.

Such an increase in pressure can be achieved by means of knurling, embossing, milling, or by means of similar surface treatments of the current collector surface. This results in the effective contact surface areas being reduced as contact is made between them. For a given force this leads to an increase of contact pressure, and thereby to an improvement of the contact. The raised locations on the surface structure make better contact with their respective bonding partners and with an appropriate selection of material can in part be plastically deformed as a result of the higher surface pressure. Where possible they compensate for clearances conditioned by manufacturing tolerances with a suitable embodiment of the surface structure and with a suitable selection of plastic materials.

In the most favourable case the deployment of plastically deformable materials can even lead, by virtue of the plastic deformation, to a subsequent increase of the effective contact surface area. Thus a contact pressure initially increased by virtue of the surface structure firstly causes a plastic deformation, which can have the result of increasing the effective contact surface area, while in actual fact reducing the contact pressure, but with an improvement of the electrical contact as the end result. The inventive increase in pressure can thus also be an increase in pressure that is only transient.

These advantageous effects occur in particular if the plastically deformable material is procured such that it opposes its deformation, at least in some phases, by means of elastic restoring forces. Such materials thus behave not in a purely plastic manner, such as, for example, a plasticine, but rather they behave—sometimes up to the arrival at an elastic limit—at least in part in an elastic manner, in order finally, however, to yield to the forces causing the deformation at least in part by means of a wholly or partially permanent deformation.

Knurled surfaces are surface structures of mainly metallic bodies, manufactured by means of a method also designated as knurling, which often have grooves, and which configure the surfaces of the mainly metallic bodies concerned so as to have more grip and are thus designed to prevent slippage. Here the increased grip is based on an increase of the local contact pressure, with the force remaining the same, as a result of the reduction of the effective surface area. The knurled surface can assume different patterns and can be introduced, for example, by means of milling or embossing.

In knurling a differentiation is made between a chip-less form of knurling involving the exertion of pressure, and a chip-forming form of knurling involving milling. Depending upon the method used the profile is either pressed into the surface with knurling wheels, or milled into the surface on a knurling milling machine.

FIG. 3 shows a detailed view of the knurled current collector of the cell shown in FIG. 2. By means of appropriate installation of suitable contact elements, such as is shown, for example, in FIG. 4, it is possible to assemble inventive galvanic cells together into blocks of cells.

In order to make contact with the current collectors in accordance with their intended purpose, care must be taken to deploy electrically conducting and insulating contact elements appropriately. Instead of the use of insulating contact elements, as is shown, for example, in FIG. 4, the space between two current collectors that are to be insulated from one another can also remain free.

1-12. (canceled)

13. A galvanic cell with flat packaging with two parallel outer surfaces and at least two flat current collectors, projecting from the packaging parallel to these outer surfaces, for purposes of connecting the cell to an energy source, an energy load, or to other galvanic cells when constructing a block of cells, wherein
the connection is made with the aid of contact elements, wherein
the current collectors in each case have two parallel surfaces, which in each case are larger than all other surfaces of the respective current collector, and
in that at least one of the current collectors, on at least one of its two parallel surfaces, has a surface structure, at least at some locations, which in a friction-locked connection of the current collector with a contact element increases the pressure, at least transiently, that the current collector and contact element exert upon one another.

14. The galvanic cell according to claim 13,
wherein the surface structure of the current collector, on at least one of its two parallel surfaces, has been generated by knurling of the surface of the current collector.

15. The galvanic cell according to claim 13,
wherein the surface structure of the current collector, on at least one of its two parallel surfaces, has been generated by embossing of the surface of the current collector.

16. The galvanic cell according to claim 13,
wherein the surface structure of the current collector, on at least one of its two parallel surfaces, has been generated by milling of the surface of the current collector.

17. The galvanic cell according to claim 16,
wherein the current collectors, at least at some locations, consist of a plastically deformable material.

18. The galvanic cell according to claim 17,
wherein the current collectors, at least at some locations, consist of a plastically deformable material, which, at least in some phases, opposes its deformation by means of elastic restoring forces.

19. A contact element for purposes of making contact with a current collector of a galvanic cell according to claim 13, characterized by a surface, which has a surface structure, at least at some locations, which in a friction-locked connection of a current collector with the contact element increases the pressure, at least transiently, that the current collector and contact element exert upon one another.

20. The contact element according to claim 19,
wherein the surface structure of the contact element has been generated by knurling of the surface of the contact element.

21. The contact element according to claim 19,
wherein the surface structure of the contact element has been generated by embossing of the surface of the contact element.

22. The contact element according to claim 18,
wherein the surface structure of the contact element has been generated by milling of the surface of the contact element.

23. The contact element according to claim 18,
wherein the contact element on its surface, at least at some locations, consists of a plastically deformable material.

24. The contact element according to claim 23,
wherein the contact element on its surface, at least at some locations, consists of a plastically deformable material, which opposes its deformation, at least in some phases, by means of elastic restoring forces.
